(19) United States
(12) Patent Application Publication
(10) Pub. No.: US 2011/0045723 A1
(43) Pub. Date: Feb. 24, 2011

(54) TWO-COMPONENT COMPOSITION FOR PRODUCING FLEXIBLE POLYURETHANE GELCOATS

(75) Inventors: Ruediger Nowak, Kandern-Egerten (DE); Thomas Schlosser, Inzlingen (DE); Reiner Wartusch, Burstadt (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, ESSEN (DE)

(21) Appl. No.: 12/988,638

(22) PCT Filed: Apr. 30, 2009
(86) PCT No.: PCT/EP09/55253

§ 371 Date: Oct. 20, 2010

(30) Foreign Application Priority Data
May 19, 2008 (DE) 102008001855.4

(51) Int. Cl. D03D 9/00; B05D 3/10; B32B 27/38; D03D 15/00; D04H 13/00

(52) U.S. Cl. 442/54; 427/386; 428/413; 442/181; 442/327

(57) ABSTRACT

Two-component composition for producing flexible polyurethane gelcoats The invention relates to the use of a two-component composition which comprises a polyol component, a polyisocyanate component and, as filler, a pyrogenically pre-pared silica which has been hydrophobicized with hexamethyldisilazane (HMDS) and then structurally modified by means of a ball mill, for producing flexible polyurethane gelcoats for epoxy resin and vinyl ester composites.

The invention relates to the use of a two-component composition which comprises a polyol component and a polyisocyanate component for producing flexible polyurethane gelcoats for epoxy resin and vinyl ester composites. The invention additionally relates to a production process for the composite, and to the composite.

The surfaces of composites (examples being composites of woven and/or nonwoven glass fibre fabric/web and epoxy resin/vinyl ester resin) are often relatively unattractive and, moreover, unstable to light and to weathering. They therefore require a surface coating. Before epoxy resin/vinyl ester resin composites are surface-coated, they must be sanded and filled, since direct surface coating with the composite may be accompanied by the standing-up of fibres. One alternative to this is the use of a gelcoat.

A gelcoat is a resin system that can be applied to mouldings in composite construction in order to produce smooth component surfaces, and at the same time also produces an attractive and, where appropriate, light-stable and weathering-stable surface. In the case of the in-mould process, the gelcoat resin system, after its reactive components have been mixed, is introduced as a first layer into a mould within the processing time (potlife). The layer obtained after gelling has sufficient mechanical stability not to be damaged when the synthetic resin (for example an epoxy resin or vinyl ester resin) and, where appropriate, an organic or inorganic web or fabric (for example, a woven glass fibre fabric or nonwoven glass fibre web) are applied. Similar comments apply to the injection process and when wet laminates are applied, and also to the application of prepregs.

In order to ensure sufficient adhesion between (i) synthetic resin (epoxy resin and/or vinyl ester resin) and (ii) gelcoat, the coating with synthetic resin must take place within the laminating time of the gelcoat resin system. Subsequently, synthetic resin and gelcoat resin system are cured completely.

In the context of the description of the invention, the following definitions of terms apply:
The laminating time is the period of time beginning with the moment the gelcoat film applied into the mould attains the tack-free state, within which the gelcoat film must be laminated in order still to ensure sufficient adhesion between gelcoat and laminate.
The potlife is the period of time beginning with the mixing of the two reactive components until the reaction mixture gels. After the end of the potlife, the reaction mixture can no longer be processed.
The tack-free time is the period of time beginning with the application of the homogeneous, initially mixed reaction mixture to the surface of the mould until the applied film attains a state of freedom from tack.
The gel time is the time measured until the reaction mixture gels, as described in E-DIN VDE 0291-2 (VDE 0291-Part 2): 1997-06 in section 9.2.1.

Gelcoat resin systems used are, for example, formulations based on free-radically curing resins such as, for example, unsaturated polyesters (UP), vinyl esters or acrylate-terminated oligomers. In application in conjunction with UP synthetic resins (UP composite materials), these resin systems have reliable processing and exhibit good adhesion to a multiplicity of synthetic resins (adhesion to composite material), since, on account of the curing reactions at the internal gelcoat surface, these reactions being inhibited by atmospheric oxygen, the boundary layer is cured only after the synthetic resin has been applied. Numerous commercial UP-based gelcoats, however, do not exhibit sufficient gloss stability and tend towards chalking and formation of hairline cracks. Further disadvantages of UP-based gelcoats are the unavoidable monomer emissions, a frequently very severe contraction in the course of curing, which leads to stresses at the composite/gelcoat boundary, and hence to poor stability of the boundary, and also the typically poor adhesion as compared with composites based on epoxy resin (EP resin) or vinyl ester resin (VE resin).

For application in conjunction with EP composite materials it is possible, for example, to use EP gelcoats (examples being those from SP-Systems). In comparison with UP gelcoats, EP gelcoats exhibit very much better adhesion to EP composite materials. EP gelcoats also contain no volatile monomers and are therefore less objectionable from the standpoint of occupational hygiene than are the majority of styrene-containing UP gelcoats. The disadvantages of EP gelcoats, however, are
the low tolerance with respect to inaccuracies in the mixing ratio, possibly leading in certain circumstances to discolorations in the cured gelcoat and severely reduced mechanical resistance,
the highly exothermic curing reaction, which allows only small batch sizes,
the very sudden curing reaction,
the inadequate weathering stability,
the very poor thermal yellowing stability,
the usually high glass transition temperature (70° C., gelcoat from SP-Systems) and hence the brittleness of the material at service temperatures significantly below the glass transition temperature, and
the high price of EP resins with some yellowing stability.

For applications, therefore, where high light stability and weathering stablity is required, surface coatings based on aliphatic polyurethanes are preferred in principle. In the formulation of PU gelcoats, however, it must be borne in mind that conventional mixtures of polyol and polyisocyanate gel only when the reaction is at a very advanced stage. At that point, however, the reaction capacity and hence the adhesion of the PU gelcoat with respect to the synthetic resin used for the composite material is greatly restricted (i.e. the tack-free time is comparatively long, while the laminating time is comparatively short). The use of a conventional product of this kind would be difficult from a processing standpoint and, furthermore, unreliable in terms of the gelcoat/synthetic resin adhesion.

Commercial aliphatic PUR gelcoats (from Relius Coatings or Bergolin) generally have comparatively low glass transition temperatures (<40° C.). In comparison to EP gelcoats, therefore, they are less brittle and can be used at curing temperatures below 80° C., and can be laminated with liquid epoxy resins. The products generally contain reactive diluents, such as polycaprolactone, for example, which under the usual curing conditions is not fully consumed by reaction and then acts as a plasticizer. Immediately after demoulding, therefore, the products are very flexible (breaking extension about 25%). Over time, however, they become brittle, presumably as a result of loss of plasticizers, and so their breaking extension drops to about half the original figure. At curing temperatures significantly above the maximum achievable glass transition temperature, Tg, of the PUR gelcoat, i.e. at temperatures >80° C., these products, after demoulding, frequently exhibit surface defects in the form of sink marks. This greatly limits the range of curing temperatures within which such a product can be employed.

With the aim of shortening the operational cycle times in the manufacture of epoxy laminates, particularly when an epoxy prepreg is used for laminate construction, it is common to employ curing temperatures above 80° C. This is also necessary when the laminate is subjected to exacting requirements in terms of heat distortion resistance. When employed in operations with curing temperatures >80° C., typical PUR gelcoats, after the component has been demoulded, frequently exhibit surface defects in the form of sink marks. For this reason, the possibility of using PUR gelcoats at curing temperatures of >80° C. is limited, and such use frequently necessitates costly and inconvenient afterwork in order to make the surface of the component smooth.

Accordingly it is an object of the invention to provide components for a polyurethane-based gelcoat resin system that do not have the stated disadvantages. The components for the gelcoat resin system ought
to result in a comparatively long laminating time in tandem with a potlife which is sufficient for mixing and introduction into the mould, and with gel times and tack-free times that are comparatively short yet sufficient for film formation,
to be easy to process (i.e. not to require additional apparatus for hot application and/or spray application),
to result in effective adhesion between gelcoat and synthetic resin (particularly with respect to epoxy resins, with long laminating times),
to produce a gelcoat which is light-stable and weathering-stable and does not tend towards formation of hairline cracks,
to produce a smooth surface of the component, free from sink marks, even at curing temperatures between 80° C. and 130° C., and
to be inexpensive.

For this purpose, indeed, polyurethane gelcoats with a high crosslinking density would in principle be especially suitable. A high crosslinking density presupposes the use of a high-functionality polyol. The use of a high-functionality polyol, however, entails a very short laminating time. Consequently it was a further object of the present invention to provide components for a flexible polyurethane gelcoat that on the one hand produce a gelcoat with a high crosslinking density, while on the other hand allowing the laminating time to be prolonged.

This object is achieved through the use of a two-component composition which comprises

A) a polyol component which comprises
A1) one or more low molecular weight polyols having a molecular weight of 160 to 600 g/mol and a hydroxyl group concentration of 5 to less than 20 mol of hydroxyl groups per kg of low molecular weight polyol,
A2) one or more higher molecular weight polyols having an average functionality of >=2 and a hydroxyl group concentration of less than 5 mol of hydroxyl groups per kg of higher molecular weight polyol, and
A3) one or more light-stable aromatic amines, and
B) a polyisocyanate component which comprises one or more polyisocyanates, where the polyol component comprises as filler a pyrogenically prepared silica which has been hydrophobicized with hexamethyldisilazane (HMDS) and then structurally modified by means of a ball mill, for producing flexible polyurethane gelcoats for synthetic resin composites, the synthetic resin comprising epoxy resin and/or vinyl ester resin and being uncured or incompletely cured on contacting.

The invention is based inter alia on the finding that light-stable aromatic amines can be added to a polyol component for producing polyurethane gelcoats and that the mixture prepared from the polyol component of the invention and from a polyisocyanate component has particularly good processing properties in the context of the production of polyurethane gelcoats and, furthermore, produces a particularly light-stable gelcoat. Cured gelcoats of the invention preferably have a Shore D hardness of more than 65 (determined in accordance with DIN EN ISO 868), and the breaking extension at 23° C. is preferably greater than 3%, more preferably greater than 5%, in particular greater than 10% (determined in accordance with ASTM-D-522), and produce excellent adhesion to epoxy and vinyl ester resins in composite materials. Suitable epoxy resins and vinyl ester resins are all commercial materials. The person skilled in the art is capable of selecting a suitable epoxy and vinyl ester resin as a function of the application of the composite material.

The cured composite material has an adhesive strength at the synthetic resin/polyurethane gelcoat boundary that is above the fracture strength of the laminating resin; in other words, in the die pull-off test, cohesive fracture occurs in the synthetic resin laminate or synthetic resin.

The synthetic resin comprises epoxy resin and/or vinyl ester resin, i.e. is a synthetic resin based on epoxy resin and/or vinyl ester resin. In one preferred embodiment the synthetic resin is epoxy resin and/or vinyl ester resin, and in one particularly preferred embodiment the synthetic resin is epoxy resin.

When the composite material is produced, i.e. on contacting with the gelcoat, the synthetic resin used is uncured or incompletely cured. Preferably the polyurethane gelcoat is incompletely cured on contacting with the synthetic resin (preferably on application of the synthetic resin). This means that preferably, in the gelcoat on contacting with the synthetic resin (preferably on application of the synthetic resin), the reaction of isocyanate groups with hydroxyl groups to form urethane groups is still not completely at an end. In all embodiments, synthetic resins are preferred which comprise woven glass fibre fabric and/or nonwoven glass fibre web or woven carbon fibre fabric or nonwoven carbon fibre scrim, the synthetic resin used being with particular preference a prepreg, more particularly an epoxy prepreg with woven glass fibre fabric and/or nonwoven glass fibre web or woven carbon fibre fabric or nonwoven carbon fibre scrim, or an injection resin.

Particular preference is given to the use of the two-component composition in an in-mould process in which the polyurethane gelcoat is partly but still not completely cured and the synthetic resin on contacting with the gelcoat is uncured or incompletely cured. In this application, the synthetic resin is preferably partly cured but not yet completely cured, and in particular comprises reinforcing material, such as woven glass fibre fabric and/or nonwoven glass fibre web or woven carbon fibre fabric or nonwoven carbon fibre scrim.

When the two-component composition is used in an injection process, after the introduction and partial gelling (partial curing) of the gelcoat, reinforcing material is inserted into the mould, the cavity filled with reinforcing material is sealed with a film, and the hollow space within the reinforcing material is evacuated. Subsequently the premixed (e.g. 2-component) synthetic resin (i.e. injection resin) is drawn under suction into the evacuated chamber and then is fully cured. In this embodiment as well, preferred reinforcing materials are woven glass fibre fabric and/or nonwoven glass fibre web or woven carbon fibre fabric or nonwoven carbon fibre scrim.

### 1. Polyol Component

A feature of the polyol component used in accordance with the invention is that it comprises at least one polyol of comparatively low molecular weight and comparatively high hydroxyl group concentration cOH. As a result of the low molecular weight polyol (or, where appropriate, the two, three, four etc. low molecular weight polyols), a very close-meshed network is formed right at the beginning of the reaction of the polyol component with a polyisocyanate component (after sufficient potlife and acceptable gel time), and this network ensures the desired mechanical stability of the gelled gelcoat.

### Low Molecular Weight Polyol

In accordance with the invention, a “low molecular weight polyol” is defined as a polyol having a molecular weight of 160 to 600 g/mol (preferably 180 to 500 g/mol, more preferably 200 to 450 g/mol and more particularly 200 to 400 g/mol) and a hydroxyl group concentration of 5 to less than 20 mol of hydroxyl groups per kg of low molecular weight polyol. The hydroxyl group concentration cOH is preferably in the range from 6 to 15, more preferably 9 to 11, mol of hydroxyl groups per kg of low molecular weight polyol.

Suitable in principle in accordance with the invention as low molecular weight polyols are all straight-chain or branched polyols that are usual for the preparation of polyurethanes, examples being polyether polyols (such as polyoxyethylenes or polyoxypropylenes), polycaprolactone polyols, polyester polyols, acrylate polyols and/or polyols based on dimeric fatty acids, and mixtures thereof.

Examples are the low molecular weight polyols listed below:
an acrylate-based polyol having a molar mass of 184 g/mol, a functionality of about 2.3 and a hydroxyl group content of 12.5 mol/kg,
a polyether polyol having a molar mass of 181 g/mol, a functionality of 3 and a hydroxyl group content of about 16.5 mol/kg and
a reaction product of trimethylolpropane and polycaprolactone, having a molar mass of 303 g/mol, a functionality of about 3 and a hydroxyl group content of about 10 mol/kg.

Further preferred low molecular weight polyols are as follows (Table 1):

TABLE 1

| | Average | Hydroxyl group |
|---|---|---|
| | molar | concentration cOH |
| | mass | (mol/kg) |
| Polycaprolactone diol | 400 | 5 |
| Polycaprolactone triol | 300 | 10 |
| Polyester polyol | 400 | 5 |
| Polypropylene oxide triol | 435 | 6.9 |
| Polypropylene oxide triol | 200 | 15.6 |
| Polytetramethylene oxide | 250 | 8 |
| diol | | |

The fraction of low molecular weight polyol (i.e. the sum of all the low molecular weight polyols in the polyol component) is preferably in the range from 2% to 60%, more preferably 5% to 50%, more particularly 10% to 45% by weight, such as 20% to 40% by weight, a fraction of 32% to 38% by weight being particularly preferred, based on the total mass of constituents A1, A2 and A3 of the polyol component.

### Higher Molecular Weight Polyol

The higher molecular weight polyol that is present in the polyol component used in accordance with the invention may in principle be any polyol that is customary for the preparation of polyurethanes, examples being polyester polyol, polyether polyol, polycarbonate polyol, polyacrylate polyol, polyol based on raw materials from fat chemistry such as, for example, dimeric fatty acids, or a natural oil, such as castor oil, for example. The polyols must have an average functionality of >=2 and a hydroxyl group concentration of less than 5, preferably 1 to 4.99, more preferably 2 to 4, more particularly 2.5 to 3.8 mol of hydroxyl groups per kg.

The constituents A1 and A2 embrace all of the polyols present in the polyol component used in accordance with the invention; in other words, a polyol which is not a low molecular weight polyol as defined above is in general considered a higher molecular weight polyol for the purposes of the present description. Preferred higher molecular weight polyols have a molecular weight of more than 600 to 8000, preferably more than 600 to 6000, more particularly more than 600 to 4000 g/mol of higher molecular weight polyol.

Suitable higher molecular weight polyols are described in the stated DE-T-690 11 540, for example. Preferred higher molecular weight polyols are polyether polyols (polyalkoxylene compounds) which are formed by polyaddition of propylene oxide and/or ethylene oxide onto low molecular weight starter compounds, with OH groups and a functionality of 2 to 8.

Further typical higher molecular weight polyols are the polyester polyols which constitute ester condensation products of dicarboxylic acids with low molecular weight polyalcohols and which have a functionality of 2 to 4, or polycaprolactones prepared starting from diols, triols or tetrols, preference being given to those higher molecular weight polyester polyols which have a hydroxyl group concentration in the range from 6 to 15 mol/kg of higher molecular weight polyester polyol, preferably 8 to 12 mol of hydroxyl groups per kg. As a result of the higher molecular weight polyol (or of the two, three, four, etc. higher molecular weight polyols, where appropriate) of the polyol component, it is ensured that a sufficiently long laminating time is available. This is important in order to achieve effective adhesion to the synthetic resin of the composite.

Particularly preferred higher molecular weight polyols are as follows:
an acrylate-based polyol having a molar mass of 606 g/mol, a functionality of about 2.3 and a hydroxyl group content of 3.8 mol/kg,
a polyether polyol having a molar mass of 803 g/mol, a functionality of about 3 and a hydroxyl group content of about 2.5 mol/kg, and
a reaction product of trimethylolpropane and polycaprolactone, having a molar mass of 909 g/mol, a functionality of about 3 and a hydroxyl group content of about 3.3 mol/kg.

By way of example the fraction of higher molecular weight polyol (i.e. the sum of all of the higher molecular weight polyols) in the polyol component is in the range from 80% to 5%, preferably 60% to 5%, more preferably 80% to 10% and more particularly 25% to 10%, by weight, based on the total mass of constituents A1, A2 and A3 of the polyol component. In one preferred embodiment the polyol component is free from aliphatic dicarboxylic acids.

Light-stable aromatic amine of low isocyanate reactivity

Suitable light-stable aromatic amines are disclosed for example in US-A-4 950 792, US-A-6 013 692, US-A-5 026 815, US-A-6 046 297 and US-A-5 962 617.

A feature of preferred light-stable aromatic amines is that, in solution in toluene (20% by weight of amine in toluene) and mixed at 23° C. with an equimolar amount of an oligomeric HDI isocyanate (hexamethylene diisocyanate) having an NCO content of about 5.2 mol/kg and a viscosity in the range from 2750 to 4250 mPas in solution in toluene (80% by weight isocyanate in toluene), they produce a gel time of more than 30 seconds, preferably more than 3 minutes, more preferably more than 5 minutes and more particularly more than 20 minutes.

One particularly preferred light-stable aromatic amine is characterized in that in solution in toluene (25% by weight of amine in toluene) and mixed at 23° C. with an equimolar amount of an oligomeric HDI isocyanate having an NCO content of about 5.2 mol/kg and a viscosity in the range from 2750 to 4250 mPas, it produces a mixture which, when applied to inert white test plates and cured in a forced-air oven at 80° C. for 30 minutes and then at 120° C. for 60 minutes, produces a coating having a dry film thickness of about 20 [mu]m, the coating having a shade change Delta E (measured in accordance with DIN 5033 part 4 and evaluated in accordance with DIN 6174) after 300 hours of artificial weathering in accordance with ASTM-G-53 (4 hours' UVB 313, 4 hours' condensation) of not more than 50, preferably not more than, more particularly not more than 40, such as not more than 30.

Light-stable aromatic amines whose use is preferred in accordance with the invention are methylenebisanilines, especially 4,4′-methylenebis(2,6-dialkylanilines), preferably the non-mutagenic methylenebisanilines described in US-A-4 950 792. Particular suitability is possessed by the 4,4′-methylenebis(3-R¹-2-R²-6-R³-anilines) that are listed in Table 2 below.

TABLE 2
4, 4′-Methylenebis (3-R¹-2-R²-6-R³-anilines)

| | R¹ | R² | R³ |
|---|---|---|---|
| Lonzacure M- | H | CH₃ | CH₃ |
| DMA | | | |
| Lonzacure M- | H | C₂H₅ | CH₃ |
| MEA | | | |
| Lonzacure M- | H | C₂H₅ | C₂H₅ |
| DEA | | | |
| Lonzacure M- | H | C₃H₇ | CH₃ |
| MIPA | | | |
| Lonzacure M- | H | C₃H₇ | C₃H₇ |
| DIPA | | | |
| Lonzacure M- | Cl | C₂H₅ | C₂H₅ |
| CDEA | | | |

The light-stable aromatic amine that is particularly preferred in accordance with the invention is 4,4′-methylenebis(3-chloro-2,6-diethylaniline), Lonzacure M-CDEA.

The fraction of light-stable aromatic amine in the polyol component (i.e. the sum of all the light-stable aromatic amines in the polyol component) is preferably in the range from 0.1% to 20% by weight, preferably 0.3% to 10% by weight, more preferably 0.5% to 5% by weight and more particularly 1% to 3% by weight, based on the total mass of constituents A1, A2 and A3 of the polyol component.

Preference here is given to two-component compositions which neither in the polyol component nor in the polyisocyanate component include an aromatic amine that is not light-stable.

### Catalysts

accelerate the polymerization reaction between polyol component and polyisocyanate component. In principle it is possible in the polyol component to use all of the catalysts known for use in polyurethanes, preferably the lead, bismuth and tin catalysts disclosed in DE-T-690 11 540, and also, in addition, the strongly basic amine catalyst 1,4-diazabicyclo[2.2.2]octane, and also zirconium compounds.

One catalyst particularly preferred in accordance with the invention for use in a polyol component is dibutyltin dilaurate (DBTL).

A polyol component used in accordance with the invention may contain up to 1%, more preferably 0.05% to 0.5% and in particular about 0.3% by weight of catalyst, 0.3% by weight for example, based on the total mass of the polyol component.

### Fillers

The polyol component of the invention comprises as filler a pyrogenically prepared silica which has been hydrophobicized by means of hexamethyldisilazane (HMDS) and subsequently structurally modified by means of a ball mill. This pyrogenically prepared (i.e. fumed) silica is known from the document DE 196 16 781 A1.

The pyrogenically prepared, HMDS-hydrophobicized and ball mill-structurally modified silica AEROSIL R 8200 can be employed with preference.

This silica has the following physicochemical parameters:

| Properties | Unit | Guide values |
|---|---|---|
| Specific surface area (BET) | m²/g | 160 ± 25 |
| C content | % by | 2.0-4.0 |
| | weight | |
| Tamped density* | g/l | about 140 |
| (approximate value) by method | | |
| based on DIN EN ISO 787/11, | | |
| August 1983 | | |
| Loss on drying* | % by | ≦0.5 |
| 2 h at 105° C. | weight | |
| pH | | ≧5.0 |
| 4% dispersion | | |
| SiO₂ content | % by | ≧99.8 |
| based on calcined substance | weight | |

*ex works

The silica has been registered as follows:

Registration

| | |
|---|---|
| CAS No. | 68909-20-6 |
| EINECS | 272-697-1 |
| TSCA (USA), | registered |
| AICS (Australia), | |
| CEPA (Canada), | |
| PICCS (Philippines) | |
| MITI (Japan) | 1-548/7-476 |
| ECL (Korea) | KE-34696 |
| NEPA (China) | List III |

The polyol component of the invention may further comprise quantities of one or more fillers, the definition of the term “filler” embracing, for the purposes of the present description, “pigment substances”. Fillers are talc, dolomite, precipitated CaCO3, BaSO4, finely ground quartz, siliceous earth, titanium dioxide, molecular sieves and (preferably calcined) kaolin. The filler content of a polyol component is preferably in the range from 10% to 80%, more preferably 20% to 70%, more particularly 35% to 55% by weight, such as 40% to 50% by weight, based on the total mass of the polyol component. Preference is given to mixtures of fillers, examples being mixtures of two, three or four fillers.

In addition the polyol component may contain ground glass fibres, examples being ground glass fibres with a length of less than 500 [mu]m. These glass fibres prevent propagation of any possible crack.

### 2. Polyisocyanate Component

Polyisocyanates used preferably in the polyisocyanate component are aliphatic isocyanates, examples being the biuret isocyanates disclosed on pages 5 and 6 of DE-T-690 11 540. All of the isocyanates specified there are suitable.

Preference is given here to the use of such aliphatic isocyanates as 1,6-hexamethylene diisocyanate (HDI), isophorone diisocyanate (IPDI), 4,4′-dicyclohexylmethane diisocyanate (H12MDI), 1,4-cyclohexane diisocyanate (CHDI), bis(isocyanatomethyl)cyclohexane (H6XDI, DDI) and tetramethylxylylene diisocyanate (TMXDI). Reference is made, moreover, to “Szycher's Handbook of Polyurethanes”, CRC Press, Boca Raton, 1999.

The silicas that can be used as fillers in the polyisocyanate component are, in particular, silanized fumed silicas. With preference it is possible to use a pyrogenically prepared silica which has been hydrophobicized with hexamethyldisilazane (HMDS) and then structurally modified by means of a ball mill. The preferred presence of silica (a thixotropic agent) in the polyisocyanate component ensures that polyol component and polyisocyanate component are readily miscible, owing to the similar viscosities of the components, and, furthermore, that the mixture of the components does not run off on a vertical surface in a wet film thickness of up to 1 mm. The amount is preferably in the range from 0.1% to 5%, more preferably 0.5% to 3%, more particularly 1% to 2%, by weight, based on the total mass of the polyisocyanate component.

### Catalysts

The catalysts which can be added to the polyol component may also be present in the polyisocyanate component, or in the polyisocyanate component instead of in the polyol component, in the stated concentrations, with preference being given to zirconium compounds as catalysts in the polyisocyanate component.

3. Additives (see textbook: “Lackadditive”, Johan H. Bielemann, Weinheim, Wiley-VCH, 1998).

Furthermore, either the polyol component or the polyisocyanate component, or both components, may additionally comprise one or more additives selected from defoaming agents, dispersants and deaerating agents.

### Defoaming Agents

may be present in an amount up to 2.0% by weight, preferably up to 1.0% by weight, based on the total mass of the component in which they are used.

### Deaerating Agents

may be present in an amount up to 2.0% by weight, preferably up to 1.0% by weight, based on the total mass of the component in which they are used. Many defoaming agents act simultaneously as deaerating agents.

### Dispersants

may be present in an amount up to 2.0% by weight, preferably up to 1.0% by weight, based on the total mass of the component to which they are added.

When the polyol component is being mixed, the polyols are typically introduced first with additives in a vacuum dissolver. The fillers and pigments are then dispersed in the polyols under vacuum. To prepare the polyisocyanate component by mixing, it is usual to introduce the polyisocyanate first and to mix it with the corresponding additives. Subsequently the filler and the thixotropic agent are incorporated by dispersion under vacuum.

(Particularly in the two-component composition of the invention), the relative amounts of polyol component and polyisocyanate component are selected such that hydroxyl groups and isocyanate groups react in the particular desired molar ratio. The molar ratio of hydroxyl groups to isocyanate groups (OH:NCO) is typically in the range from 1:3 to 3:1, preferably 1:2 to 2:1, more preferably 1:1.5 to 1.5:1. In one particularly preferred embodiment the OH:NCO ratio is close to a stoichiometric molar ratio of 1:1, i.e. in the range from 1:1.2 to 1.2:1, preferably 1:1.1 to 1.1:1, and with more particular preference there is equimolar reaction, i.e. the relative amounts of polyol component and polyisocyanate component are chosen such that the molar ratio of the hydroxyl groups to isocyanate groups is about 1:1.

The gelling of the mixture of the two components takes place either at room temperature or, if accelerated gelling is desired, at an elevated temperature. Gelling may take place, for example, at a temperature of 40° C., 60° C. or else 80° C. In the case of the particularly preferred mixture of the components of the two-component composition of the invention, however, a temperature increase for the purpose of accelerating gelling is not absolutely necessary.

The synthetic resin preferably comprises one or more reinforcing materials, such as woven fabrics, nonwoven scrims or nonwoven webs, for example, or preshaped elements produced by weaving or stitching, quilting or adhesive bonding of woven fabrics, nonwoven scrims or nonwoven webs. These materials may be made of glass fibres, carbon fibres, aramid fibres or polyester fibres or of any other thermoplastic polymer fibres. Preferred reinforcing materials are woven glass fibre fabrics and/or nonwoven glass fibre webs or woven carbon fibre fabrics or nonwoven carbon fibre scrims.

When the formation of a gel of sufficient mechanical stability is at an end, synthetic resin, epoxy resin for example, and, if desired, woven glass fibre fabric or nonwoven glass fibre web, is applied to the gelcoat within the laminating time. By means of polyol components of the invention and two-component compositions of the invention, it is ensured that the laminating time available for lamination is in the range from about 20 minutes to 72 hours, typically about 48 hours. The process of laminating to gelcoats is no different from the laminating processes that are employed without use of gelcoats and are described for example in “Faserverbundbauweisen” by M. Flemming, G. Ziegmann, S. Roth, Springer, Berlin, Heidelberg, New York, 1996. The curing of the gelcoats takes place typically at an elevated temperature.

In a further embodiment the invention provides a process for producing synthetic resin composites with flexible polyurethane gelcoats, comprising

(i) mixing a two-component composition which comprises
A) a polyol component which comprises
A1) one or more low molecular weight polyols having a molecular weight of 160 to 600 g/mol and a hydroxyl group concentration of 5 to less than 20 mol of hydroxyl groups per kg of low molecular weight polyol,
A2) one or more higher molecular weight polyols having an average functionality of >=2 and a hydroxyl group concentration of less than 5 mol of hydroxyl groups per kg of higher molecular weight polyol, and
A3) one or more light-stable aromatic amines, and
B) a polyisocyanate component which comprises one or more polyisocyanates, the polyol component comprising as filler a pyrogenically prepared silica which has been hydrophobicized with hexamethyldisilazane (HMDS) and then structurally modified by means of a ball mill, and at least partly (and preferably only partly) curing the mixture, and
(ii) contacting the mixture with synthetic resin, the synthetic resin comprising epoxy resin and/or vinyl ester resin and being uncured or incompletely cured on contacting with the gelcoat.

The invention further provides a synthetic resin composite with flexible polyurethane gelcoat which is obtainable by the aforesaid process. One particularly preferred composite is a wind blade, i.e. a rotor blade for wind turbines, or a part thereof.

The two-component composition used in accordance with the invention affords the following advantages:
It is a system composed of only two components and is therefore easy to process.
The potlife is only 10 to 15 minutes.
The mixture of polyol component and polyisocyanate component is tack-free within 20 to 70 minutes, even with a coat thickness of 0.5 mm and at room temperature. No heating is necessary to achieve this.
The laminating time at room temperature is more than 72 hours, thus creating very good conditions for adhesion to epoxy resin and vinyl ester resin laminates.
The mixture of the two components is secure against runoff from a vertical surface in a wet film thickness of up to 1 mm.
The viscosity of the polyisocyanate component, set preferably using silica, provides for ready miscibility of the two components.
The compounds used in preparing the two components are convenient from the standpoint of occupational hygiene and are emission-free in processing.
The two components produce a transparent gelcoat and can therefore be given any desired pigmentation.
The mixed components can be employed additionally as a filling compound or as a coating which need not be applied by the in-mould process.
The mixture of the components is self-levelling.
Complete curing of the mixture of the two components can be achieved with 30 minutes to 2 hours even at temperatures of 50 to 160° C.

The gelcoat produced in accordance with the invention possesses the following advantageous properties:
Good weathering stability.
A long laminating time for short gel time and tack-free time.
After demoulding, smooth surfaces are obtained on components, without surface defects, despite the fact that the glass transition temperature Tg, at about 40° C., is comparatively low.
High resistance to hydrolysis.
High chemical stability.
High abrasion resistance in conjunction with high flexibility (Tg 40° C. and Shore D hardness=74).
Good sandability. After treatment of the gelcoat is in principle unnecessary. However, where large components are assembled from a number of individual parts, it is necessary to seal the abutting edges with filling compounds. Excess filler is generally removed by sanding.

In order to obtain smooth transitions, it is necessary for the gelcoat to be readily sandable. The same applies if repair work becomes necessary on a mechanically damaged surface.
The gelcoat is substantially free from reactive diluents and plasticizers.

1-12. (canceled)

13. A process for producing a synthetic resin composite with a flexible polyurethane gelcoat, comprising
(i) mixing a two-component composition which comprises
A) a polyol component which comprises
A1) one or more low molecular weight polyols having a molecular weight of 160 to 600 g/mol and a hydroxyl group concentration of 5 to less than 20 mol of hydroxyl groups per kg of low molecular weight polyol,
A2) one or more higher molecular weight polyols having an average functionality of >=2 and a hydroxyl group concentration of less than 5 mol of hydroxyl groups per kg of higher molecular weight polyol, and
A3) one or more light-stable aromatic amines, and
B) a polyisocyanate component which comprises one or more polyisocyanates, the polyol component comprising as filler a pyrogenically prepared silica which has been hydrophobicized with hexamethyldisilazane (HMDS) and then structurally modified by means of a ball mill,
and at least partly curing the mixture, and
(ii) contacting the mixture with synthetic resin, the synthetic resin comprising epoxy resin and/or vinyl ester resin and being uncured or incompletely cured on contacting with the gelcoat.

14. A synthetic resin composite with flexible polyurethane gelcoat, obtained by the process according to claim 13.

15. A wind blade or part thereof comprising the synthetic resin composite according to claim 14.

16. The process according to claim 13, wherein the synthetic resin comprises one or more reinforcing materials selected from the group consisting of woven glass fibre fabric, nonwoven glass fibre web, woven carbon fibre fabric and nonwoven carbon fibre scrim.

17. The process according to claim 13, wherein the synthetic resin is a prepreg,

18. The process according to claim 13, wherein the synthetic resin is an epoxy resin prepreg with woven glass fibre fabric and/or nonwoven glass fibre web, or an injection resin.

19. The process according to claim 13, wherein the light-stable aromatic amine is a methylenebisaniline.

20. The process according to claim 13, wherein the light-stable aromatic amine is 4,4′-methylenebis(3-chloro-2,6-diethylaniline).

21. The process according to claim 13, wherein the fraction of light-stable aromatic amine in the polyol component, based on the total mass of constituents A1, A2 and A3 of the polyol component, is in the range from 0.1% to 20% by weight.

22. The process according to claim 13, wherein the fraction of low molecular weight polyol in the polyol component, based on the total mass of constituents A1, A2 and A3 of the polyol component, is in the range from 2% to 60% by weight.

23. The process according to claim 13, wherein the hydroxyl group concentration of the low molecular weight polyol is in the range from 6 to 15 mol of hydroxyl groups per kg of low molecular weight polyol.

24. The process according to claim 13, wherein the low molecular weight polyol is selected from the group consisting of a straight-chain or branched polycaprolactone diol, a polycaprolactone triol, a polycaprolactone tetrol, a polyester polyol, a polypropylene oxide triol, a polyether polyol and a polytetramethylene oxide diol.

25. The process according to claim 13, wherein the higher molecular weight polyol is selected from the group consisting of a polyester polyol, a polyether polyol, a polycarbonate polyol, a polyacrylate polyol, and a polyol based on raw materials from fat chemistry, wherein the raw material is a dimeric fatty acids or a natural oil.

26. The process according to claim 13, wherein the higher molecular weight polyol has a hydroxyl group concentration of 1 to 4.99 mol of hydroxyl groups per kg of higher molecular weight polyol.

27. The process according to claim 13, wherein the fraction of higher molecular weight polyol in the polyol component, based on the total mass of constituents A1, A2 and A3 of the polyol component, is in the range from 97% to 30% by weight.

28. The process according to claim 13, wherein the light-stable aromatic amine is 4,4′-methylenebis(2,6-dialkylaniline).

29. The process according to claim 13, wherein the higher molecular weight polyol has a hydroxyl group concentration of 2.5 to 3.8 mol of hydroxyl groups per kg of higher molecular weight polyol.

30. The process according to claim 13, wherein the fraction of higher molecular weight polyol in the polyol component, based on the total mass of constituents A1, A2 and A3 of the polyol component, is in the range from 70% to 50% by weight.

31. The process according to claim 13, wherein the fraction of light-stable aromatic amine in the polyol component, based on the total mass of constituents A1, A2 and A3 of the polyol component, is in the range from 1% to 3% by weight.
